(19) United States
(12) Patent Application Publication
(10) Pub. No.: US 2024/0320296 A1
(43) Pub. Date: Sep. 26, 2024

(54) Determining Matching Data

(71) Applicant: Mastercard International Incorporated, New York, NY (US)

(72) Inventor: Nicola Mariella, Oranmore (IE)

(21) Appl. No.: 18/579,485

(22) PCT Filed: Jun. 7, 2022
(86) PCT No.: PCT/US2022/032425

§ 371 Date: Jan. 15, 2024

(30) Foreign Application Priority Data
Jul. 16, 2021 (GB) 2110276.9

(51) Int. Cl. G06F 17/16

(52) U.S. Cl. CPC G06F 17/16

(57) ABSTRACT

The computer implemented image matching method involves the use of a quantum computer communicating with a classical computer. The method includes the following steps: (a) The classical computer receives input data. (b) The classical computer generates an input graph representing the input data, (c) The classical computer augments the input graph, (d) An iteration block is performed. (e) The iteration block is repeated using the new permutation parameter, the permuted first adjacency matrix, and a new existing graph until a threshold is met. In the first iteration of the iteration block, the accumulated permutation is the identity, making the permuted first adjacency matrix equal to the first adjacency matrix. The first graph is isomorphic with the second graph when the loss is minimized, indicating a match between the first data and the existing data.

### CROSS REFERENCE TO RELATED APPLICATION

This application claims the benefit of United Kingdom Patent Application No. 2110276.9, which was filed on Jul. 16, 2021, the entire contents of which are hereby incorporated by reference for all purposes.

### TECHNICAL FIELD

The present disclosure relates to quantum computing. In particular, the present disclosure relates to a computer-implemented method and corresponding computing device for determining whether an input data matches an existing data.

### BACKGROUND

Quantum computers exploit the quantum superposition characteristics of particles to determine the optimal solution to complex non-linear problems. Unlike classical computers where a classical memory bit will take either a value of “1” or a value of “0”; in a quantum computer, a quantum bit or “qubit” may take a value of “1”, “0” or a superposition of “1” and “0”. By resolving the value of a plurality of qubits, the quantum computer can determine the minimum energy state of the qubits and so determine in one computation cycle the optimum solution to a given problem.

In order to exploit the processing efficiency of a quantum computer to solve a complex real world problem, the real world problem and variable may need to be expressed to the quantum computer in a resolvable manner. Determining how to express the problem and variables may be a computationally expensive task which may require more processing cycles than would be needed to solve the problem using a traditional iterative method.

The present disclosure has been devised to mitigate or overcome at least some of the above-mentioned problems.

### SUMMARY OF THE DISCLOSURE

In accordance with a first aspect of the present disclosure, there is provided a computer implemented method for determining a graph isomorphism of a first graph and a second graph using a quantum computer in communication with a classical computer, comprising the steps of: (a) augmenting, by the classical computer, the first graph and the second graph; (b) determining, by the classical computer, a first adjacency matrix of the augmented first graph and a second adjacency matrix of the augmented second graph; (c) determining, by the classical computer, a second unitary operator representation of the second adjacency matrix; (d) performing an iteration block, the iteration block comprising: (i) permuting, by the classical computer, the first adjacency matrix according to an accumulated permutation, thereby generating a permuted first adjacency matrix; (ii) determining, by the classical computer, a first unitary operator representation of the permuted first adjacency matrix; (iii) generating, by the classical computer, a parametric circuit plan based on: a permutation parameter of a set of permutation parameters; a hyper-parameter of a set of permutation parameters; (iv) implementing, on the quantum computer, a quantum circuit based on: the first unitary operator representation; the second unitary operator representation; and the parametric circuit plan; wherein a parametric circuit portion of the quantum circuit permutes the permuted first adjacency matrix according to a permutation based on the permutation parameter; (v) executing and measuring, by the quantum computer, a quantum state of the quantum circuit; (vi) determining, by the classical computer, a loss of a loss function based on the quantum state; (vii) updating, by the classical computer, the accumulated permutation by applying the permutation to the accumulated permutation; and (viii) selecting, by the classical computer, a new permutation for the iteration block parameter based on the loss; (e) repeating the iteration block using the new permutation parameter and the permuted first adjacency matrix; wherein the iteration block is repeated until a threshold is met; wherein in a first iteration of the iteration block, the accumulated permutation is the identity such that the permuted first adjacency matrix is equal to the first adjacency matrix; and wherein the first graph is isomorphic with the second graph when the loss is minimized.

Preferably, the iteration block further comprises: (ix) determining, by the classical computer, a discrepancy between the permuted first graph and the second graph; (x) determining, by the classical computer, that the discrepancy is indicative of a perfect solution; and (xi) recording, by the classical computer, the perfect solution; wherein the perfect solution comprises the permuted first graph.

Preferably, the classical computer minimizes the loss of the loss function when selecting the new permutation.

Preferably, the new permutation parameter is selected by a classical optimizer of the classical computer.

Preferably, step (a) comprises: adding a first set of ancillary singleton vertices to the first graph such that the first graph comprises 2^{k} vertices; adding a second set of ancillary singleton vertices to the second graph such that the second graph comprises a power of 2^{f} vertices. The skilled person will understand that in some embodiments, f may be equal to k, such that the first graph comprises the same number of vertices as the second graph. Accordingly, the first set of ancillary singleton vertices may be equal to the second set of ancillary singleton vertices. Preferably, the first set of ancillary singleton vertices comprises 2┌log₂|V_{A}|┐−|V_{A}| ancillary singleton vertices, and the second set of ancillary singleton vertices comprises 2┌log₂|V_{B}|┐|V_{B}| ancillary singleton vertices; wherein |V_{A}| is the number of vertices in the first graph; and wherein |V_{B}| is the number of vertices in the second graph. The skilled person will understand that |V_{A}| may be equal to |V_{B}|.

Preferably, step (c) comprises: determining, by the classical computer, an injective mapping; applying, by the classical computer, the injective mapping to the second adjacency matrix; and determining, by the classical computer, an exponential mapping of the mapped second adjacency matrix.

Preferably, step (e) comprises: applying, by the classical computer, the injective mapping to the permuted first adjacency matrix; and determining, by the classical computer, an exponential mapping of the mapped permuted first adjacency matrix.

Preferably, the injective mapping is configured to map elements of a first domain to corresponding elements of a second domain.

Preferably, the first domain is the set of all N by N symmetric matrices on the finite field and the second domain is the set of all N² by N² matrices in the complex field.

Preferably, the quantum circuit comprises: a first, a second, and a third set of k qubits; wherein 2^{k} is the number of vertices comprised in the augmented first graph; a first set of k Hadamard gates configured to act on the third set of k qubits; a first unitary operator configured to act on the first and second set of k qubits; a parametric operator configured to act on the first, the second, and the third set of k qubits; a second unitary operator configured to act on the first and second set of k qubits; and a second set of k Hadamard gates configured to act on the third set of k qubits.

Preferably, the first unitary operator implements the first unitary representation of the permuted first adjacency matrix; the parametric operator implements the parametric circuit plan; and the second unitary operator implements the second unitary representation of the second adjacency matrix.

Preferably, the parametric operator permutes the permuted first adjacency matrix.

Preferably, step (f) is repeated until a usable hyper-parameter is reached.

Preferably, the set of hyper-parameters are predetermined based on a structure of the adjacency matrices and properties of the quantum computer.

Preferably, the first graph comprises the same number of vertices as the second graph.

Preferably, the threshold is a determination that the first graph is isomorphic with the second graph.

Preferably, the first graph comprises a greater number of vertices than the second graph.

Preferably, the threshold is a predetermined iteration threshold.

In accordance with a second aspect of the present disclosure, there is provided a computer implemented data matching method using a quantum computer in communication with a classical computer, comprising the steps of: (a) receiving, by the classical computer, an input data; (b) generating, by the classical computer, an input graph representative of the input data; (c) augmenting, by the classical computer, the input graph; (d) performing an iteration block, the iteration block comprising: (i) retrieving, from an existing graph database of the classical computer, an existing graph; (ii) augmenting, by the classical computer, the existing graph; (iii) determining, by the classical computer, a first adjacency matrix of the augmented input graph and a second adjacency matrix of the augmented existing graph; (iv) permuting, by the classical computer, the first adjacency matrix according to an accumulated permutation, thereby generating a permuted first adjacency matrix; (v) determining, by the classical computer, a first unitary operator representation of the permuted first adjacency matrix, and a second unitary operator representation of the second adjacency matrix; (vi) generating, by the classical computer, a parametric circuit plan based on: a permutation parameter of a set of permutation parameters; a hyper-parameter of a set of permutation parameters; (vii) implementing, on the quantum computer, a quantum circuit based on: the first unitary operator representation; the second unitary operator representation; and the parametric circuit plan; wherein a parametric circuit portion of the quantum circuit permutes the permuted first adjacency matrix according to a permutation based on the permutation parameter; (viii) executing and measuring, by the quantum computer, a quantum state of the quantum circuit; (ix) determining, by the classical computer, a loss of a loss function based on the quantum state; (x) updating, by the classical computer, the accumulated permutation by applying the permutation to the accumulated permutation; and (xi) selecting, by the classical computer, a new permutation for the iteration block parameter based on the loss; (e) repeating the iteration block using: the new permutation parameter; the permuted first adjacency matrix; and a new existing graph; wherein the iteration block is repeated until a threshold is met; wherein in a first iteration of the iteration block, the accumulated permutation is the identity such that the permuted first adjacency matrix is equal to the first adjacency matrix; wherein the first graph is isomorphic with the second graph when the loss is minimized; and wherein the first data matches the existing data when the first graph is isomorphic with the second graph.

The input data may be, for example, an input image. The input image may be, for example, a fingerprint image of a human fingerprint such that the method determines whether the fingerprint image matches a fingerprint image stored in a fingerprint image database. Alternatively, the input image may be a facial image such that the method determines whether the facial image matches a facial image in a facial image database. In a further alternative, the input image may be an integrated circuit layout such that the method determines whether the integrated circuit layout corresponds to a circuit diagram of a circuit diagram database. In a further alternative, the input image may be an input financial transaction map and the existing images may instead be financial pattern templates. In this case, the method may identify that the input financial transaction map matches a financial pattern template, which may be indicative of unauthorised or unconventional transactions such as transactions associated with an instance of money laundering. The skilled person will appreciate that the method may apply to any data that may be represented as a graph.

### BRIEF DESCRIPTION OF THE DRAWINGS

One or more embodiments of the disclosure will now be described, by way of example only, with reference to the accompanying drawings, in which:

FIG. 1 is a computing system;

FIG. 2 is a method for determining whether a graph of a first graph is isomorphic with a second graph, in accordance with a first aspect of the present disclosure;

FIG. 3a is an example first graph;

FIG. 3b is an example second graph;

FIG. 4 is a method for determining a unitary operator representation of an adjacency matrix; Figure Sa is an example quantum circuit for determining a loss;

FIG. 5b is an example circuit construction for a unitary operator representation of an example graph;

FIG. 5c is the example graph;

FIG. 6a is a first subgraph of the first graph that is isomorphic with the second graph;

FIG. 6b is a second subgraph of the first graph that is isomorphic with the second graph; and

FIG. 7 is a method for determining whether an input data matches an existing data, in accordance with a second aspect of the present disclosure.

### DETAILED DESCRIPTION

The present disclosure relates to a computer-implemented method

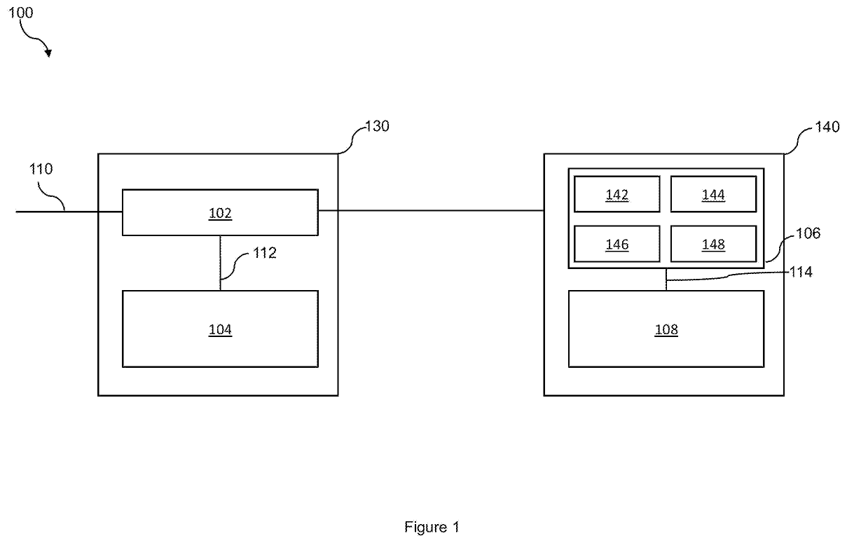

FIG. 1 shows a computing system 100 comprising a classical computer 130. The classical computer 130 comprises a CPU 102 coupled to provide data to, and receive data from, a conventional memory 104 by means of a memory interface 112. Input information may be received by the CPU from an interface 110. Output information may be provided by the CPU to the interface 110. The classical computer 130 may further comprise additional classical computing elements as known in the art (not shown).

The classical computer 130 is coupled to a quantum computer 140. The quantum computer 140 comprises a quantum computing unit 106 and a quantum memory unit 108, a plurality of coupling devices 142, a bias device 144, and a state determination device 146.

The quantum computing unit 106 comprises a number N of qubits 148. The qubits 148 may be for example, superconducting flux devices 148 having a circulating current. For example, the superconducting flux devices 148 may comprise a loop of superconducting material interrupted by at least one Josephson junction, as is known in the art. Further qubit implementations may be envisaged. The quantum computing unit 106 is configured to provide transactions to, and receive transactions from, the quantum memory unit 108 by means of a memory interface 114.

A “state” of the quantum computing unit 106 corresponds to the respective state of all of the N qubits. An example state of a qubit is a 0 state. The 0 state may correspond to, for example, a clockwise current around the superconducting flux devices 148 which may induce a downward magnetic field. A counter clockwise current around the superconducting flux devices may induce an upwards magnetic field which references a state 1.

The state of the quantum computing unit 106 may be described by a bit string having a length N. Thus, there are 2^{N} possible configurations for the state of the quantum computing unit 106. The quantum computer 140 is a quantum annealer. Other quantum computing models may be envisaged.

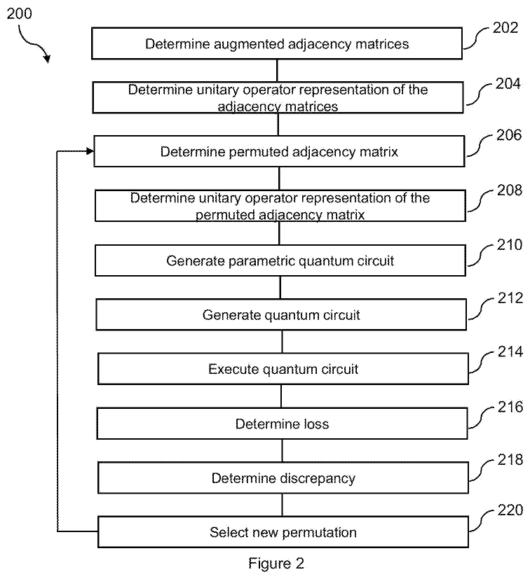

The following section provides an iterative method 200, according to FIG. 2, for determining whether a first graph is isomorphic with a second graph. In the present example, the method 200 is applied to a first graph S and a second graph R using the classical computer 130 and the quantum computer 140. If an injective edge-preserving mapping exists from the vertices of the second graph R to the vertices of the first graph S, then the second graph R is isomorphic with the first graph S.

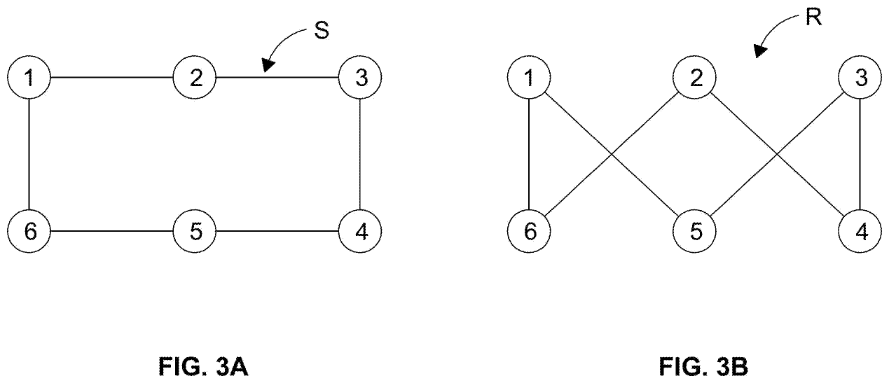

The first graph S is depicted in FIG. 3a and comprises a first set of vertices V_{S}, wherein V_{S}={s₁, s₂, . . . , sₙ} and n is the total number of vertices in the first set of vertices V_{S}. The vertices of the first set of vertices V_{S} are connected via a first set of edges E_{S}, wherein the edges are undirected.

The second graph R is depicted in FIG. 3b and comprises a second set of vertices V_{R}, wherein V_{R}={r₁, r₂, . . . , rₘ} and m is the total number of vertices in the second set of vertices. The vertices of the second set of vertices V_{R} are connected via a second set of edges E_{R}, wherein the edges are undirected.

In the present example, the first graph S comprises the same number of vertices as the second graph R, such that n=m. In particular, the first graph S and the second graph R each comprise 6 vertices.

The skilled person will understand that in sub-graph isomorphism cases, the first graph S comprises a greater number of vertices than the second graph R, such that n>m. In such a case, the present method 200 may instead be a method for determining whether a sub-graph S^{s} of the first graph S is isomorphic with the second graph R. The sub-graph S^{s} is a graph having vertices that are a subset of the vertices of the first graph S, determined by the image of the mapping.

In the sub-graph isomorphism case, the method 200 may include an additional step 201. In the additional step 201, a set of sub-graphs of the first graph S is determined, wherein each sub-graph S′ has a number of vertices equal to the number of vertices of the second graph R. In this case, a first sub-graph S′ takes the place of the first graph A in the method 200. The method 200 may be iterated for the first sub-graph S′ of the set of sub-graphs until a threshold number of iterations is met. When the threshold number of iterations is met, a new sub-graph S″ of the set of sub-graphs takes the place of the first sub-graph S′. Alternatively, the method 200 may be iterated until a first solution is reached. In this way, a sub-graph isomorphism may be determined for each of the sub-graph of the set of sub-graphs.

The method 200 requires determination of an adjacency matrix. In a general case, an adjacency matrix M of a graph with n vertices is an n by n matrix having matrix elements M_{i,j}, wherein i and j correspond to vertices mᵢ and mⱼ in a set of vertices Vₘ associated with the graph. The matrix elements M_{i,j} are determined such that a matrix element M_{i,j} is 1 if an edge connects vertex mᵢ to mⱼ, and is 0 if there is no edge connecting vertex mᵢ to mⱼ. That is, the matrix element M_{i,j} is 1 if {i,j} is an edge of the first set of edges Eₘ:

$${M}_{i , j} = \{ \begin{matrix}1 , & \{ i , j \} ∈ {E}_{m} \\ 0 , & otherwise\end{matrix}$$

The skilled person will understand that due to the undirected nature of the edges, the matrix element M_{i,j} is equal to a matrix element M_{j,i}, and as such, the adjacency matrix M is symmetric. The adjacency matrix M is also binary, such that M_{i,j}∈Z₂. Without loss of generality, the adjacency matrix M comprises dimensions that are a power of two, such that the number of vertices n=2^{k}, wherein k is a natural number (k∈N).

The adjacency matrix M for the general case may be represented as:

$$M = {\sum }_{i , j} {M}_{i , j} \vert i 〉 〈 j \vert$$

Applying this adjacency matrix formulation to the first graph S and the second graph R, the first adjacency matrix A′ for the first graph S of FIG. 3a and the second adjacency matrix B′ for the second graph R of FIG. 3b are:

$${A}^{′} = \vert \begin{matrix}0 & 1 & 0 & 0 & 0 & 1 \\ 1 & 0 & 1 & 0 & 0 & 0 \\ 0 & 1 & 0 & 1 & 0 & 0 \\ 0 & 0 & 1 & 0 & 1 & 0 \\ 0 & 0 & 0 & 1 & 0 & 1 \\ 1 & 0 & 0 & 0 & 1 & 0\end{matrix} \vert \\ {B}^{′} = \vert \begin{matrix}0 & 0 & 0 & 0 & 1 & 1 \\ 0 & 0 & 0 & 1 & 0 & 1 \\ 0 & 0 & 0 & 1 & 1 & 0 \\ 0 & 1 & 1 & 0 & 0 & 0 \\ 1 & 0 & 1 & 0 & 0 & 0 \\ 1 & 1 & 0 & 0 & 0 & 0\end{matrix} \vert$$

The method 200 requires a quantum circuit representation of the adjacency matrices. In order to represent an adjacency matrix M on a quantum circuit having k qubits, and thus an underlying 2^{k} dimensional Hilbert space, the adjacency matrix M requires a power of 2 size (i.e. 2^{k} by 2^{k}). In cases where the number of vertices n in a set of vertices V_{M} is not a power of 2, a set of ancillary singleton vertices V_{M}′ is added to the set of vertices V_{M}. The set of ancillary singleton vertices V_{M}′ comprises 2┌log₂|V_{M}|┐−|V_{M}| vertices. The skilled person will understand the ┌x┐ term to be a ceiling function of a real number x.

The skilled person will understand that the ancillary singleton vertices may instead be introduced as entries on the corresponding adjacency matrix.

Therefore, at step 202 of the method 200, the first graph S and the second graph R are augmented using a set of ancillary singleton vertices. The set of ancillary singleton vertices comprises 2┌log₂|V_{A}|┐−|V_{A}| vertices such that an augmented first graph S′ comprises n′ vertices. The skilled person will understand that the same number of ancillary singleton vertices are added to the second graph R, since the second graph R comprises the same number of vertices as the first graph S. Accordingly, an augmented second graph R′ comprises m′ vertices, wherein n′ and m′ are both a power of 2.

For the first graph S, the number of vertices n is 6, such that |V_{A}|=6. Accordingly, the set of ancillary singleton vertices comprises 2┌log₂┐6=2 vertices. Therefore, the augmented first graph S′ comprises 8 vertices. The augmented second graph R′ also comprises 8 vertices.

At step 204, a first adjacency matrix A of the augmented first graph S′ and a second adjacency matrix B of the augmented second graph R′ are determined.

The addition of the ancillary singleton vertices corresponds to the addition of a single qubit at most. The ancillary singleton vertices are unconnected to the vertices of the respective graph, such that the first and second augmented adjacency matrices A and B are:

$$A = ( \begin{matrix}{A}^{′} & {0}_{{n}^{′} - n} \\ {0}_{{n}^{′} - n} & {0}_{{n}^{′} - n}\end{matrix} ) \\ B = ( \begin{matrix}{B}^{′} & {0}_{{m}^{′} - m} \\ {0}_{{m}^{′} - m} & {0}_{{m}^{′} - m}\end{matrix} )$$

In the present example, the augmented first graph S′ and the augmented second graph R′ both comprise 8 vertices, 2 of which are ancillary singleton vertices. Accordingly, the first and second adjacency matrices A, B are matrices of size 8 by 8. In particular, the first and second adjacency matrices A, B are:

$$A = \vert \begin{matrix}0 & 1 & 0 & 0 & 0 & 1 & 0 & 0 \\ 1 & 0 & 1 & 0 & 0 & 0 & 0 & 0 \\ 0 & 1 & 0 & 1 & 0 & 0 & 0 & 0 \\ 0 & 0 & 1 & 0 & 1 & 0 & 0 & 0 \\ 0 & 0 & 0 & 1 & 0 & 1 & 0 & 0 \\ 1 & 0 & 0 & 0 & 1 & 0 & 0 & 0 \\ 0 & 0 & 0 & 0 & 0 & 0 & 0 & 0 \\ 0 & 0 & 0 & 0 & 0 & 0 & 0 & 0\end{matrix} \vert \\ B = \vert \begin{matrix}0 & 0 & 0 & 0 & 1 & 1 & 0 & 0 \\ 0 & 0 & 0 & 1 & 0 & 1 & 0 & 0 \\ 0 & 0 & 0 & 1 & 1 & 0 & 0 & 0 \\ 0 & 1 & 1 & 0 & 0 & 0 & 0 & 0 \\ 1 & 0 & 1 & 0 & 0 & 0 & 0 & 0 \\ 1 & 1 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} \vert$$

The skilled person will understand that adjacency matrices already having a matrix of power of 2 size will remain unchanged by this augmentation step. Accordingly, the augmented adjacency matrices A and B may be the same as the first and second adjacency matrices A′ and B′ if the first and second adjacency matrices A′ and B′ are already power of 2 sized matrices.

In the sub-graph isomorphism case, a first graph may have a number of vertices to a power of 2, whilst a second graph may not (or vice-versa). In this case, a trivial augmentation may be applied to the graph having a number of vertices to a power of 2 such that no ancillary singleton vertices are added.

Next, at step 206 a second unitary operator representation B corresponding to the second augmented adjacency matrix B is determined. A first unitary operator representation Â corresponding to the first augmented adjacency matrix A may optionally also be determined.

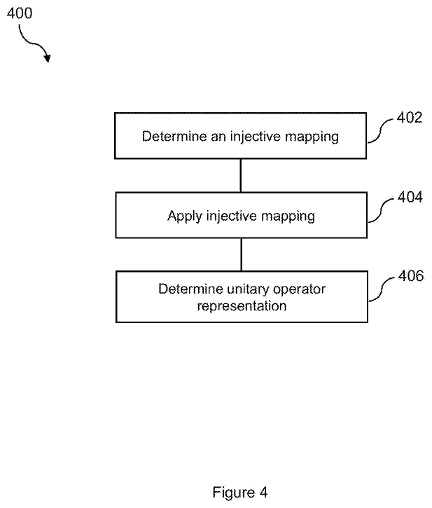

The unitary operator representations B, and optionally Â, are determined following a unitary operator representation method 400 shown in FIG. 4.

At step 402 of the method 400, an injective mapping h is determined. The injective mapping h is configured to map elements of a first domain, S_{N}( [symbol] ₂), to corresponding elements of a second domain, [symbol] _{N}_{²}( [symbol] ). The skilled person will understand that the first domain S_{N}( [symbol] ₂) is the set of all N by N symmetric matrices on the finite field F₂={0,1} and the second domain [symbol] _{N}_{²}( [symbol] ) is the set of all N² by N² matrices in the complex field [symbol] . Accordingly, the injective mapping h maps an N by N matrix to an N² by N² matrix and as such, a unitary operator of the N² by N² requires log₂(N)=2k qubits. In particular, the injective mapping h flattens a matrix in the first domain S_{N}( [symbol] ₂) (the first domain matrix) along a diagonal of a matrix in the second domain [symbol] _{N}_{²} ( [symbol] ) (the second domain matrix). Therefore, basis vectors |i [symbol] j| of the first domain matrix are mapped to the diagonal basis of the second domain matrix, wherein the diagonal basis of the second domain matrix is |i, j [symbol] i, j|. The skilled person will understand that |i, j [symbol] i, j|=|i [symbol] i|⊗|j [symbol] j|, wherein ⊗ is a tensor product. At step 404, the injective mapping h is applied to the second augmented adjacency matrix B, to generate a mapped adjacency matrix h(B):

$$h ( B ) = i π {\sum }_{i , j} {B}_{i , j} \vert i , j 〉 〈 i , j \vert$$

The skilled person will understand that the mapped adjacency matrix h(B) is skew-Hermitian, since a matrix Hermitian h(B)* of the mapped adjacency matrix h(B) is equal to a negative of the mapped adjacency matrix h(B), i.e., h(B)=−h(B). An image of the injective mapping h on the second domain [symbol] N² ( [symbol] ) is a subset of a Lie algebra u(N²), such that h(S_{N}( [symbol] ₂))⊂u(N²). Accordingly, a matrix exponential mapping of the mapped adjacency matrix h(B) takes h(S_{N}( [symbol] ₂)) to the unitary group U(N²).

Additionally, at step 404, the injective mapping h is optionally applied to the second adjacency matrix A, to generate a mapped adjacency matrix h(A), wherein:

$$h ( A ) = {\sum }_{i , j} {A}_{i , j} \vert i 〉 〈 j \vert {\to }_{h} i π {\sum }_{i , j} {A}_{i , j} \vert i , j 〉 〈 i , j \vert$$

At step 406, the second unitary operator representation B is determined for the first augmented adjacency matrix B. The second unitary operator representation B is an exponential mapping of the mapped adjacency matrix h(B′):

\hat{B}:=e^{Ad(H}^{^{⊗2k}}^{)h(B)}

Wherein H is a 2 by 2 matrix corresponding to the Hadamard operator on a single qubit, and H^{⊗2k} denotes the parallel action of 2k Hadamard operators. The skilled person will understand that Ad(a)B is a standard notation in Lie Theory for indicating a conjugation action of an invertible matrix a on a matrix B, such that Ad(a) takes B to aBa⁻¹. In the present case, the matrix a is the corresponding matrix of the Walsh-Hadamard operator H^{⊗2k} The Walsh-Hadamard operator H^{⊗2k} is self-adjoint and unitary and as such, Ad (H^{⊗2k})B=H^{⊗2k}BH^{⊗2k} The unitary operator representations Â and \hat{B} are therefore:

$$\hat{A} = {H}^{{⊗}_{2 k}} [ {\sum }_{i , j} {e}^{i π {A}_{i , j}} \vert i , j 〉 〈 i , j \vert ] {H}^{{⊗}_{2 k}} \\ \hat{B} = {H}^{{⊗}_{2 k}} [ {\sum }_{i , j} {e}^{i π {B}_{i , j}} \vert i , j 〉 〈 i , j \vert ] {H}^{{⊗}_{2 k}}$$

Turning now to step 208 of the method 200, a permuted adjacency matrix TAT^{T} of the first graph S is determined by the classical computer 130. The permuted adjacency matrix TAT^{T} comprises an accumulated permutation T.

It is noted that the accumulated permutation T is applied classically (i.e. by the classical computer 130) to the adjacency matrix A prior to a subsequent determination of a unitary representation of the permuted adjacency matrix TAT^{T}. The accumulated permutation Tₜ₊₁ of a subsequent iteration t+1 is obtained by applying a permutation P(cₜ) of a current iteration t to the accumulated permutation Tₜ of the current iteration t, such that Tₜ₊₁←P(cₜ)·Tₜ.

In a first iteration (i.e., t=0) of the method 200, the accumulated permutation T is the identity, since no permutation P(cₜ) has been applied. Accordingly, the initial permuted adjacency matrix TAT^{T} is the augmented adjacency matrix A, optionally determined in step 206.

The permuted adjacency matrix TAT^{T} of the first graph S is isomorphic with the second graph R if, in terms of the augmented first adjacency matrix A and the augmented second adjacency matrix B:

TAT⁻¹=B

The skilled person will understand that the above equation corresponds to applying the accumulated permutation T to the rows and columns of the augmented first adjacency matrix A, such that a permuted first adjacency matrix TAT⁻¹ equates the augmented second adjacency matrix B. Additionally, the skilled person will understand that, in the present context, the accumulated permutation T indicates the accumulated permutation as both an operator, and as a matrix.

The permutation permutes elements of a set, wherein the set in the present case is {0, 1, . . . , 2^{k}−1}, wherein 2^{k} is the number of vertices of the augmented graphs. The accumulated permutation T is implemented by a bijective mapping function ƒ_{T}, wherein f_{T} is configured to bijectively map elements i of the set to respective vectors of the standard basis for a vector space of dimension 2^{k}. The permutation matrix is configured to permute these vectors. In the present case, the bijective mapping function ƒ_{T} is configured to bijectively map elements i of the set to vectors f_{T}(i), wherein the vectors f_{T}(i) are basis vectors of the permutation matrix T. Accordingly, the permuted first adjacency matrix TAT⁻¹ corresponds to a unitary operator representation of the permuted first adjacency matrix [symbol] :

$$= T [ \hat{A} ] = {H}^{{⊗}_{2 k}} [ {\sum }_{i , j} {e}^{i π {A}_{i , j}} \vert {f}_{P} ( i ) , {f}_{P} ( j ) 〉 〈 {f}_{P} ( i ) , {f}_{P} ( j ) \vert ] {H}^{{⊗}_{2 k}}$$

At step 210, a unitary operator representation [symbol] of the permuted adjacency matrix TAT^{T} is determined following the method 400. In particular, the permuted adjacency matrix TAT^{T} is mapped by the injective mapping h at step 404, such that a mapped adjacency matrix h(TAT^{T}) is generated. The unitary operator representation [symbol] according to step 406 is therefore:

[symbol]

:=e^{Ad(H}^{^{⊗2k}}^{)h(TAT}^{^{T}}⁾

At step 212, a parametric circuit plan \tilde{P}ₕ(θ) is generated for encoding a parametric circuit \tilde{P}ₕ(θ) on a quantum circuit on the quantum computer 140.

The parametric circuit \tilde{P}ₕ(θ) will be known to the skilled person, and comprises an ansatz Qₕ(θ), wherein the ansatz Qₕ(θ) is a k-qubit parametric operator corresponding to a real amplitudes circuit. The real amplitudes circuit is a heuristic trial wave function comprising alternating layers of Y rotations and CX entanglements. The ansatz Qₕ(θ) is dependent on a vector of parameters θ and a vector of hyper-parameters h.

The parametric circuit \tilde{P}ₕ(θ) is configured to facilitate application of a permutation P(cₜ) to the permuted first adjacency matrix TAT^{T}, wherein the permutation P(cₜ) is based on a discretized parameter component cₜ. The discretized parameter component cₜ is a discretization of the vector of parameters θ. The discretized parameter component ci is determined at step 226 of each iteration. It is noted that the parametric \tilde{P}ₕ(θ) is, in general, not itself a permutation matrix, and may instead be a superposition of a plurality of permutations. However, the discretization process applied post-optimization at each iteration of the method facilitates application of the permutation P(cₜ).

The hyper-parameters h determine the topological characteristics of the parametric quantum circuit, such as a number of layers of the circuit and a structure of couplings between the layers. The hyper-parameters h are predetermined based on the structure of the adjacency matrices and the properties of the quantum computer 140. The choice of an orthogonal operator is justified by the permutation matrices being a subset of the set of orthogonal matrices. However, a permutation matrix P of the permutation P(cₜ) may not be represented with sufficient fidelity by the ansatz Qₕ(θ) due to full entanglement being required which is physically impossible for large matrix sizes. Accordingly, the success of such representation may depend on the hyper-parameters h. Step 210 may be repeated with different hyper-parameter h settings until a usable hyper-parameter h is reached. The hyper-parameter h settings may be determined by random sampling according to the limits of the quantum computer 140.

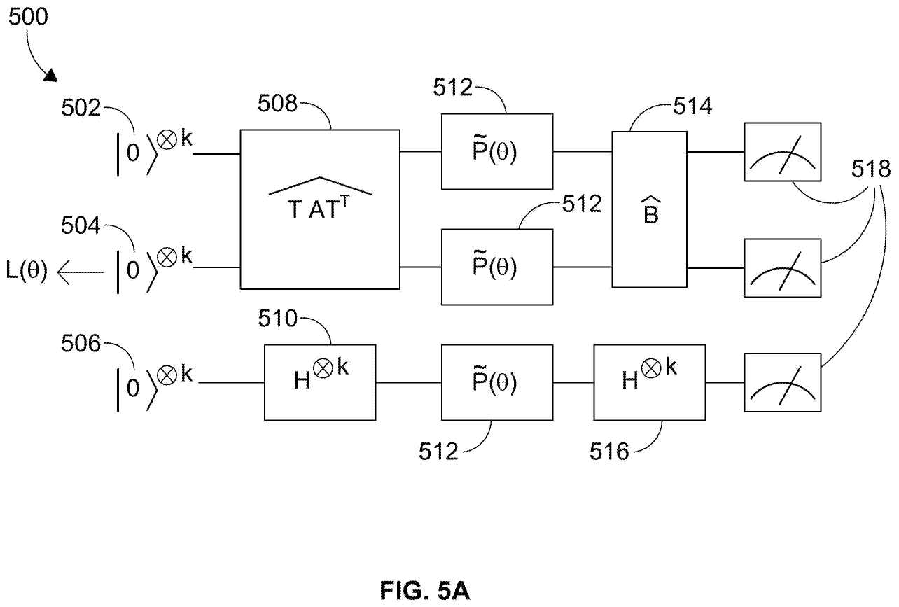

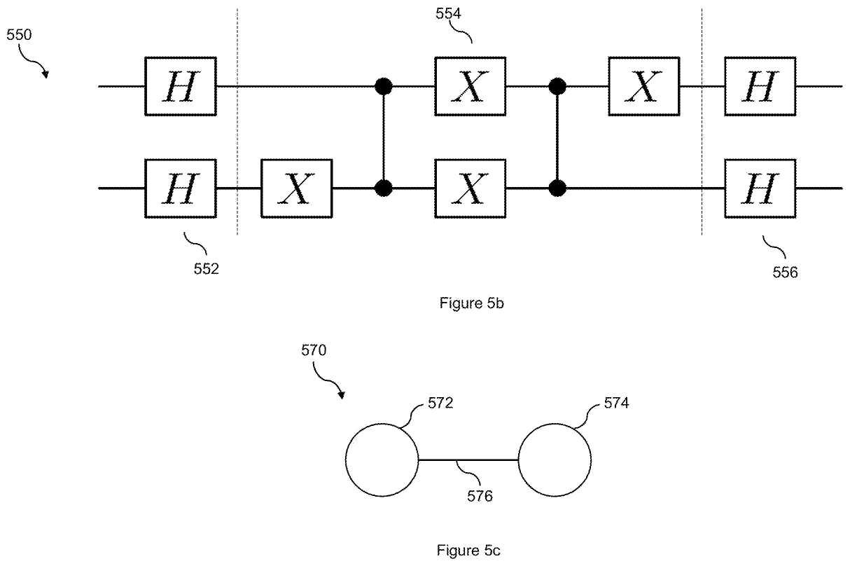

At step 214, a quantum circuit 500 corresponding to a loss function L(A,B) is generated. FIG. 5a depicts an example quantum circuit 500. The quantum circuit 500 is configured to implement the unitary operator of the permuted adjacency matrix [symbol] , the parametric quantum circuit \tilde{P}ₕ(θ), and the second unitary operator representation B.

The quantum circuit 500 comprises: a first set of k qubits 502, a second set of k qubits 504, and a third set of k qubits 506, wherein 2^{k} is the number of vertices of the augmented first graph S and the augmented second graph R. The first and second sets of k qubits 502, 504 address the 2^{k} rows and columns of the matrices respectively. Accordingly, applying the same permutation to the first and second sets of k qubits 502, 504 corresponds to permuting the adjacency matrix as in the classical case. In the quantum circuit 500, all qubits are initialised in the |0) state.

The quantum circuit 500 comprises a unitary operator 508 corresponding to the unitary representation of the permuted first adjacency matrix [symbol] . The unitary operator 508 is applied to the first and second sets of qubits 502, 504. The unitary operator 508 may be constructed through conjugation by a Walsh-Hadamard transform acting on a diagonal operator. The circuit construction will depend on the matrix elements A_{i,j} and requires 2k qubits, as outlined in an example circuit construction 550 depicted in FIG. 5b.

In the sub-graph isomorphism case where the first graph S comprises a greater number of vertices than the second graph R, 2^{k} is the number of vertices of the first graph S.

The example circuit construction 550 depicted in figure Sb implements a unitary operator representation \hat{X} of a 2 by 2 adjacency matrix X of an example graph 570 shown in FIG. 5c. The unitary operator representation \hat{X} may be determined following the method 400. The graph 570 comprises a first vertex 572 and a second vertex 574, with a single bidirectional edge 576 between the first vertex 572 and the second vertex 574. The adjacency matrix X is therefore:

$$X = ( \begin{matrix}0 & 1 \\ 1 & 0\end{matrix} )$$

Accordingly, the adjacency matrix X is 2¹ by 2¹, and as such, k=1 for this example. The circuit 550 implementing the first unitary operator representation \hat{X} therefore comprises 2 qubits. The circuit 550 comprises a first portion 502 corresponding to the first H^{⊗2k} term, a second portion 554 corresponding to the [Σ_{i,j}e^{iπX}^{_{i,j}}|i,j [symbol] i, j|] term, and a third portion 556 corresponding to the second H^{⊗2k} term.

The skilled person will understand that in the present case, the adjacency matrix A of the augmented first graph S requires 6 qubits, since the augmented adjacency matrix A is a matrix of size 2³ by 2³, and as such, k=3.

Turning back to the quantum circuit 500, the circuit 500 further comprises a first set of k Hadamard gates 510, each Hadamard gate being configured to act on a respective qubit of the third set of qubits 506.

The quantum circuit 500 further comprises a parametric operator 512. The parametric operator 512 is configured to act on each of the first, second, and third sets of qubits 502, 504, 506. The parametric operator 512 corresponds to the parametric operator \tilde{P}ₕ(θ). The parametric operator \tilde{P}ₕ(θ) acting on the first unitary operator representation Â may be defined as:

$${\tilde{P}}_{h} ( θ ) [ \hat{A} ] = ( {Q}_{h} ( θ ) ⊗ {Q}_{h} ( θ ) \cdot \hat{A} \cdot {Q}_{h}^{T} ( θ ) ⊗ {Q}_{h}^{T} ( θ ) )$$

When the ansatz Qₕ(θ) implements a permutation P,|+ [symbol] ^{⊗2k} is a fixed state shared for all permutations, since the 2k qubits are always initialised in the |0 [symbol] state and H^{⊗2k} gates are applied. Accordingly, when implementing the parametric operator \tilde{P}ₕ(θ) in the measurement, the Qₕ^{T}(θ)⊗Qₕ^{T}(θ) term may be simplified to the identity I.

The quantum circuit 500 further comprises a unitary operator 514 configured to act on the first and second sets of qubits 502, 504. The unitary operator 514 corresponds to the second unitary operator representation \hat{B}. The unitary operator 514 may be constructed in a similar manner to the example of FIG. 5b.

The quantum circuit 500 further comprises a second set of Hadamard gates 516 configured to act on the third set of qubits 506 following the parametric operator 512.

Finally, the quantum circuit 500 comprises a set of measurement gates 518 configured to project a quantum state of each of the qubits to one of the basis vectors |0 [symbol] or |1 [symbol] .

At step 216, using the quantum computer 140, the quantum circuit 500 is executed and measured using the measurement gates 518. The measurement of the quantum circuit 500 is provided to the classical computer 130.

At step 218, the classical computer 130 determines a loss of the quantum circuit 500 based on the measurement of the quantum circuit 500, following the below loss function.

An expectation value of the loss function L(A,B) is determined based on the measurement of step 216. The measurement is based on an observable [symbol] , wherein the observable [symbol] =|0 [symbol] ^{⊗2k} [symbol] 0|^{⊗2k}. In particular, the loss function L(A,B) is:

$${{L ( A , B ) = 1 - 〈 0 \vert}^{{⊗}_{2 k}} {\hat{A}}^{†} \cdot {\hat{B}}^{†} 𝒪 \hat{B} \cdot \hat{A} \vert 0 〉}^{{⊗}_{2 k}}$$

Using the unitary representation Â(\hat{B})^{†}=(\hat{B})^{†}Â=Â·\hat{B}, the loss function L(A,B) may be formulated as:

$${{L ( A , B ) = 1 - {\vert 〈 0 \vert}^{{⊗}_{2 k}} \hat{B} \cdot \hat{A} \vert 0 〉}^{{⊗}_{2 k}} \vert}^{2}$$

Using the unitary representation for the first and second adjacency matrices Â and \hat{B}, and since e^{iπA}^{_{i,j}}=−1^{A}^{_{i,j}}, the loss function L(A,B) may be formulated as:

$${{L ( A , B ) = 1 - {\vert 〈 0 \vert}^{{⊗}_{2 k}} {H}^{{⊗}_{2 k}} [ {\sum }_{i , j} - {1}^{{A}_{i , j} + {B}_{i , j}} \vert i , j 〉 〈 i , j \vert ] {H}^{{⊗}_{2 k}} \vert 0 〉}^{{⊗}_{2 k}} \vert}^{2}$$

Since a Hadamard gate maps the basis state |0 [symbol] to |+ [symbol] , the loss function L(A,B) may be formulated as:

$${{L ( A , B ) = 1 - {\vert 〈 + \vert}^{{⊗}_{2 k}} [ {\sum }_{i , j} - {1}^{{A}_{i , j} + {B}_{i , j}} \vert i , j 〉 〈 i , j \vert ] \vert + 〉}^{{⊗}_{2 k}} \vert}^{2}$$

Finally, the loss function L(A,B) may be formulated as:

$$L ( A , B ) = 1 - \frac{1}{\vert A \vert} {\vert {\sum }_{i , j} - {1}^{{A}_{i , j} + {B}_{i , j}} \vert}^{2}$$

Accordingly, in an ideal case, a loss function L(A ‘,B’) for the un-augmented first adjacency matrices A′ and B′ is minimised when the first adjacency matrix A′ is equal to the second adjacency matrix B′. In particular, when A_{i,j} is equal to B_{i,j}, the exponent of −1 is even so the term−1^{A}^{_{i,j}}^{+B}^{_{i,j}} is positive. When A_{i,j} is not equal to B_{i,j}, the exponent of −1 is odd so the term−1^{A}^{_{i,j}}^{+B}^{_{i,j}} is negative. Overall the positive values for each match and the negative values for each mismatch are accumulated and as such, the loss is minimized when A′ and B′ coincide.

In a non-ideal case there is a full mismatch between the non-augmented adjacency matrices A′ and B′ such that B′=A′+J_{N} with respect to the addition on {0, 1}, wherein J_{N} is an N by N matrix with all entries as ones. Due to the non-physical meaning of the phase, the use of augmented adjacency matrices A and B is used in the loss function L(A,B), in place of the first adjacency matrix A and the second adjacency matrix B, respectively. In this case, when the loss function L(A,B)=0, it may be deduced that A′=B′ and as such, A′ and B′ are isomorphic. The skilled person will understand that the loss function L may also be minimised when B=A+J_{N}.

At step 220, an adjacency matrix discrepancy d is determined using the classical computer 130. In this way, at the end of each iteration, the classical computer 130 can determine whether a perfect solution is present. If a perfect solution is present, the permuted adjacency matrix TAT^{T} of the current iteration can be recorded in a list of solutions. The discrepancy d is determined by:

$$d = {‖ {TAT}^{T} - B ‖}_{F}$$

Wherein the term ∥X∥_{F} is the Frobenius norm of a matrix X.

Optionally, at step 222, a stop condition may be implemented wherein upon reaching a perfect solution, the method 200 ends. Alternatively, the discrepancy d may be compared with a predetermined tolerance discrepancy dₜₒₗ, and if the tolerance discrepancy dₜₒₗ is met, the methods ends. The method may instead end when a threshold number of iterations has been met.

At step 224, the accumulated permutation T is updated by applying the permutation P(cₜ) to the accumulated permutation T. That is, the permutation P(cₜ) of the current iteration t is applied to the accumulated permutation T, thereby producing an updated accumulated permutation Tₜ₊₁, such that Tₜ₊₁+P(cₜ)·Tₜ. The updated accumulated permutation Tₜ₊₁ is configured to be used as the accumulated permutation T for the subsequent iteration t+1.

At step 226, a new permutation P(cₜ) is determined by selecting a new discretized parameter component ci of the vector of parameters θ. This new permutation P(cₜ) is classically applied to the accumulated permutation T of the current iteration t, such that a new permuted adjacency matrix TAT^{T} is generated for use in a subsequent iteration t+1 of the method 200. The new accumulated permutation T therefore accumulates the preceding permutation components, such that Tₜ₊₁←P(cₜ)·Tₜ. The current iteration t ranges from a first iteration, t=0, to a maximum iteration t=tₘₐₓ. Every permutation may be decomposed as a composition of swaps (i.e. simple permutations of two elements). The proposed method therefore builds a final permutation iteratively.

Through each iteration of the method 200 the new discretized parameter component ci is selected by the classical optimizer. The classical optimizer is configured to select the new discretized parameter component cₜ such that the loss function is minimized. In other words, the loss is iteratively optimized by the classical optimizer by changing the discretized parameter component cₜ minimizing the expectation value of the loss function.

The new discretized parameter component cₜ of the vector of parameters θ may be selected using a classical optimiser, such as Cobyla, configured to produce a discretized parameter component cₜ which minimises a mismatch between the permuted first adjacency matrix TAT^{T} and the second adjacency matrix B. The mismatch will be understood as representing a measure of a partial matching between the permuted first adjacency matrix TAT^{T} and the second adjacency matrix B when the permuted adjacency matrix TAT^{T} does not exactly match the second adjacency matrix B. The mismatch is proportional to the loss determined in step 216. The goal of the classical optimiser is to minimise the loss and correspondingly minimise the mismatch.

The Ansatz Qₕ(θ) is impeded from implementing the identity permutation in order to avoid trivial stalls.

Steps 208 to 226 are repeated until a threshold number of repetitions is met or the tolerance discrepancy is met.

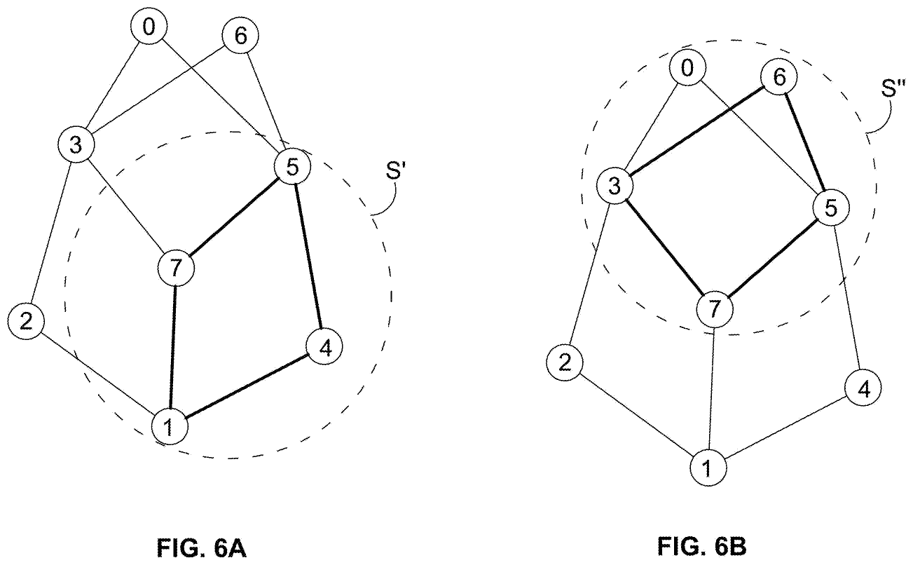

Examples solutions to the method 200 (with respect to sub-graph isomorphism) are shown in FIG. 6a and FIG. 6b. FIG. 6a shows a first subgraph section S′ of a graph S which is isomorphic with a pattern graph R. FIG. 6b shows a second subgraph section S″ of the graph S, which is also isomorphic with the pattern graph R. The subgraph sections S′, S″ each correspond to a distinct solution of the method 200 using the pattern graph R and the graph S.

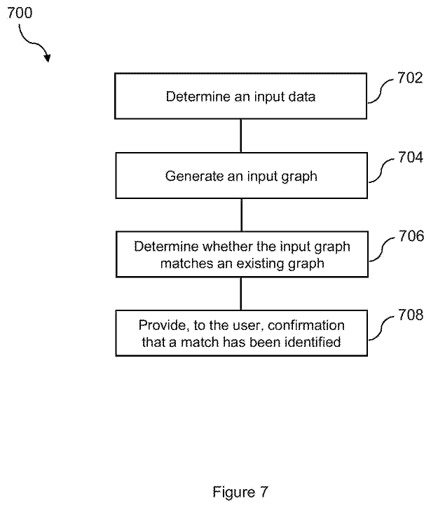

FIG. 7 depicts a method 700 for determining whether an input data matches an existing data stored in a database on the conventional memory 104 of the classical computer 130.

In the present example, the input data is an input image, the existing data is an existing image, and the database is an image database.

The image database comprises a plurality of existing images that may have been previous input images, or an image downloaded from a third party source such as a third party server. The skilled person will understand that the existing images may have been acquired via any suitable means.

The conventional memory 104 comprises a graph library. The graph library comprises a plurality of existing graphs, each existing graph being associated with a respective existing image. The existing graphs each respectively comprise a set of nodes Vₑ (i.e. vertices) and a set of undirected edges Eₛ connecting the nodes. The nodes and edges uniquely identify the corresponding existing image. The nodes correspond to respective pixels or sets of pixels of the corresponding existing image.

In a first step 702 of the method 700, the classical computer 130 receives an input image.

The input image may be, for example, a fingerprint image of a human fingerprint such that the method 700 determines whether the fingerprint image matches a fingerprint image stored in a fingerprint image database. Alternatively, the input image may be a facial image such that the method 700 determines whether the facial image matches a facial image in a facial image database. In a further alternative, the input image may be an integrated circuit layout such that the method 700 determines whether the integrated circuit layout corresponds to a circuit diagram of a circuit diagram database. In a further alternative, the input image may be an input financial transaction map and the existing images may instead be financial pattern templates. In this case, the method may identify that the input financial transaction map matches a financial pattern template, which may be indicative of unauthorised or unconventional transactions such as transactions associated with an instance of money laundering. The skilled person will appreciate that the method 700 may apply to any data that may be represented as a graph.

The input image may be acquired via an external imaging device in communication with the classical computer 130. Alternatively, the input image may be received from a third party server. The skilled person will understand that the input image may be received via any suitable means.

At step 704, the classical computer 130 generates an input graph representative of the input image. The input graph comprises a set of nodes Vᵢ (i.e. vertices) and a set of undirected edges E; connecting the nodes. The nodes and edges uniquely identify the input image. The nodes may correspond to respective pixels or sets of pixels of the input image. The edges between vertices may represent a desired distance metric. The skilled person will understand that any suitable method may be used to generate the input graph corresponding to the input image, such as image segmentation.

At step 706, the classical computer 130 and the quantum computer 140 determine whether the input image matches an existing image. In particular, the method 200 is employed, with the first graph being the input graph, and the second graph being an existing graph of the set of existing graphs. The method 200 is iterated until a graph isomorphism is determined, or a threshold number of iterations is reached. If a graph isomorphism is detected, then the input image matches the existing image corresponding to the existing graph.

Step 706 is repeated with a new existing graph of the set of existing graphs until a match is determined, or all of the existing graphs of the set of existing graphs have been assessed iteratively.

At step 708, the classical computer 130 provides, to the interface 110, confirmation that a match has been identified if a matching image has been determined in step 706, or a confirmation that no match has been identified if no matching image has been determined in step 706.

Some embodiments may assign computer processing tasks to recipient processors, for example, but not limited to CPUs, GPUs, DSPs, GP-GPUs, quantum processor and/or processors optimised for artificial intelligence tasks. In such embodiments, the processors are the recipients and the processing tasks are the opportunities. In such embodiments, in for example, a complex cloud computing infrastructure a large number of tasks, of differing types, requiring execution may be received and a large number of processors may be housed within the cloud computing infrastructure.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method for determining a graph isomorphism of a first graph and a second graph using a quantum computer in communication with a classical computer, comprising the steps of:
(a) augmenting, by the classical computer, the first graph and the second graph;
(b) determining, by the classical computer, a first adjacency matrix of the augmented first graph and a second adjacency matrix of the augmented second graph;
(c) determining, by the classical computer, a second unitary operator representation of the second adjacency matrix;
(d) performing an iteration block, the iteration block comprising:
(i) permuting, by the classical computer, the first adjacency matrix according to an accumulated permutation, thereby generating a permuted first adjacency matrix;
(ii) determining, by the classical computer, a first unitary operator representation of the permuted first adjacency matrix;
(iii) generating, by the classical computer, a parametric circuit plan based on:
a permutation parameter of a set of permutation parameters;
a hyper-parameter of a set of permutation parameters;
(iv) implementing, on the quantum computer, a quantum circuit based on:
the first unitary operator representation;
the second unitary operator representation; and
the parametric circuit plan;
wherein a parametric circuit portion of the quantum circuit permutes the permuted first adjacency matrix according to a permutation based on the permutation parameter;
(v) executing and measuring, by the quantum computer, a quantum state of the quantum circuit;
(vi) determining, by the classical computer, a loss of a loss function based on the quantum state;
(vii) updating, by the classical computer, the accumulated permutation by applying the permutation to the accumulated permutation; and
(viii) selecting, by the classical computer, a new permutation parameter for an iteration block parameter based on the loss;
(e) repeating the iteration block using the new permutation parameter and the permuted first adjacency matrix;
wherein the iteration block is repeated until a threshold is met;
wherein, in a first iteration of the iteration block, the accumulated permutation is an identity such that the permuted first adjacency matrix is equal to the first adjacency matrix; and
wherein the first graph is isomorphic with the second graph when the loss is minimized.

2. The method of claim 1, wherein the iteration block further comprises:
(ix) determining, by the classical computer, a discrepancy between a permuted first graph and the second graph;
(x) determining, by the classical computer, that the discrepancy is indicative of a perfect solution; and
(xi) recording, by the classical computer, the perfect solution,
wherein the perfect solution comprises the permuted first graph.

3. The method of claim 1, wherein the classical computer minimizes the loss of the loss function when selecting the new permutation.

4. The method of claim 3, wherein a new permutation parameter is selected by a classical optimizer of the classical computer.

5. The method of claim 1, wherein step (a) comprises:
adding a first set of ancillary singleton vertices to the first graph such that the first graph comprises 2^{k} vertices; and
adding a second set of ancillary singleton vertices to the second graph such that the second graph comprises a power of 2^{f} vertices.

6. The method of claim 5, wherein the first set of ancillary singleton vertices comprises 2┌log₂|V_{A}|┐−|V_{A}| ancillary singleton vertices, and the second set of ancillary singleton vertices comprises 2┌log₂|V_{B}|┐−|V_{B}| ancillary singleton vertices;
wherein |V_{A}| is a number of vertices in the first graph; and
wherein |V_{B}| is a number of vertices in the second graph.

7. The method of claim 1, wherein step (c) comprises:
determining, by the classical computer, an injective mapping;
applying, by the classical computer, the injective mapping to the second adjacency matrix; and
determining, by the classical computer, an exponential mapping of the mapped second adjacency matrix.

8. The method of claim 7, wherein step (e) comprises:
applying, by the classical computer, the injective mapping to the permuted first adjacency matrix; and
determining, by the classical computer, an exponential mapping of the mapped permuted first adjacency matrix.

9. The method of claim 7, wherein the injective mapping is configured to map elements of a first domain to corresponding elements of a second domain.

10. The method of claim 9, wherein the first domain is the set of all N by N symmetric matrices on a finite field and the second domain is the set of all N² by N² matrices in the complex field.

11. The method of claim 1, wherein the quantum circuit comprises:
a first, a second, and a third set of k qubits;
wherein 2^{k} is the number of vertices comprised in the augmented first graph;
a first set of k Hadamard gates configured to act on the third set of k qubits;
a first unitary operator configured to act on the first and second set of k qubits;
a parametric operator configured to act on the first, the second, and the third set of k qubits;
a second unitary operator configured to act on the first and second set of k qubits; and
a second set of k Hadamard gates configured to act on the third set of k qubits.

12. The method of claim 11, wherein:
the first unitary operator implements the first unitary representation of the permuted first adjacency matrix;
the parametric operator implements the parametric circuit plan; and
the second unitary operator implements the second unitary representation of the second adjacency matrix.

13. The method of claim 11, wherein the parametric operator permutes the permuted first adjacency matrix.

14. The method of claim 1, wherein step (iii) is repeated until a usable hyper-parameter is reached.

15. The method of claim 1, wherein the set of hyper-parameters are predetermined based on a structure of the adjacency matrices and properties of the quantum computer.

16. The method of claim 1, wherein the first graph comprises the same number of vertices as the second graph.

17. The method of claim 16, wherein the threshold is a determination that the first graph is isomorphic with the second graph.

18. The method of any of claim 1, wherein the first graph comprises a greater number of vertices than the second graph.

19. The method of claim 1, wherein the threshold is a predetermined iteration threshold.

20. A computer implemented data matching method using a quantum computer in communication with a classical computer, comprising the steps of:
(a) receiving, by the classical computer, an input data;
(b) generating, by the classical computer, an input graph representative of the input data;
(c) augmenting, by the classical computer, the input graph;
(d) performing an iteration block, the iteration block comprising:
(i) retrieving, from an existing graph database of the classical computer, an existing graph;
(ii) augmenting, by the classical computer, the existing graph;
(iii) determining, by the classical computer, a first adjacency matrix of the augmented input graph and a second adjacency matrix of the augmented existing graph;
(iv) permuting, by the classical computer, the first adjacency matrix according to an accumulated permutation, thereby generating a permuted first adjacency matrix;
(v) determining, by the classical computer, a first unitary operator representation of the permuted first adjacency matrix, and a second unitary operator representation of the second adjacency matrix;
(vi) generating, by the classical computer, a parametric circuit plan based on:
a permutation parameter of a set of permutation parameters;
a hyper-parameter of a set of permutation parameters;
(vii) implementing, on the quantum computer, a quantum circuit based on:
the first unitary operator representation;
the second unitary operator representation; and
the parametric circuit plan;
wherein a parametric circuit portion of the quantum circuit permutes the permuted first adjacency matrix according to a permutation based on the permutation parameter;
(viii) executing and measuring, by the quantum computer, a quantum state of the quantum circuit;
(ix) determining, by the classical computer, a loss of a loss function based on the quantum state;
(x) updating, by the classical computer, the accumulated permutation by applying the permutation to the accumulated permutation; and
(xi) selecting, by the classical computer, a new permutation for an iteration block parameter based on the loss;
(e) repeating the iteration block using:
the new permutation parameter;
the permuted first adjacency matrix; and
a new existing graph;
wherein the iteration block is repeated until a threshold is met;
wherein in a first iteration of the iteration block, the accumulated permutation is the identity such that the permuted first adjacency matrix is equal to the first adjacency matrix;
wherein a first graph is isomorphic with the second graph when the loss is minimized; and
wherein the first data matches the existing data when the first graph is isomorphic with the second graph.
